(19) United States
(12) Patent Application Publication
(10) Pub. No.: US 2010/0105143 A1
(43) Pub. Date: Apr. 29, 2010

(54) SAMPLE ANALYZER, SAMPLE ANALYZING METHOD, AND COMPUTER PROGRAM PRODUCT

(75) Inventor: Yoshiyuki KAWAMURA, Kobe-shi (JP)

Correspondence Address: SUGHRUE MION, PLLC, 2100 PENNSYLVANIA AVENUE, N.W., SUITE 800, WASHINGTON, DC, 20037, US

(73) Assignee: SYSMEX CORPORATION, Kobe-shi (JP)

(21) Appl. No.: 12/581,542

(22) Filed: Oct. 19, 2009

(30) Foreign Application Priority Data
Oct. 23, 2008 (JP) 2008-272629

(51) Int. Cl. G01N 35/00; G01N 35/02

(52) U.S. Cl. 436/43; 422/67

(57) ABSTRACT

A sample analyzer comprising: a plurality of measuring units for measuring samples and outputting measurement data; a transporting device for transporting samples to be measured to the respective measuring units; a data processor for processing the measurement data output from at least one of the measuring units; a connection state information obtainer for automatically obtaining connection state information relating to connection state of the measuring units; and a transport controller for controlling operation of the transporting device in accordance with the connection state information obtained by the connection state information obtainer, is disclosed. A sample analyzing method and a computer program product are also disclosed.

### FIELD OF THE INVENTION

The present invention relates to a sample analyzer provided with a plurality of measuring units for analyzing samples such as blood, urine, and the like, and which is capable of transporting samples to the plurality of measuring units, sample analyzing method and computer program product.

### BACKGROUND

Many conventional sample analyzers for measuring the size of minute particles in a sample such as blood or urine and analyzing the distribution state of these particles are being developed. In order to measure various samples by effective measuring methods, a plurality of types of measuring units are connected, and samples are transported to one of the measuring units which measures the samples by effective measuring methods.

Since the transport line is assembled when the plurality of measuring units are in a connected state, it is not easy to remove, add, or replace the measuring units. That is, modifying the transport line is not easy whenever the measuring units are removed, added, or replaced when there are differing sizes, structures, and configurations among the measuring devices.

U.S. Pat. No. 6,019,945 discloses a sample analysis system capable of easily removing, adding, and replacing analysis units even in the case of different types of analysis units by mutually identically shaped mountings and mounting structures for the transport lines of similar analysis (measuring) units.

Although modifying the physical connections of the devices is easy in the sample analysis system disclosed in U.S. Pat. No. 6,019,945, the computer program which controls analysis and transporting and the like must be set in accordance with the type and number of analysis units. In order to properly control the operation of the analysis units by the computer program, however, the type and number of changed analysis units must be properly set and a problem arises in that a level of skill is required to perform the setting operations.

When the type and number of analysis units is modified, therefore, a specialist must be dispatched to the site from the manufacturer of the sample analysis system to perform the setting operations, which becomes a factor in increasing the maintenance costs.

### SUMMARY OF THE INVENTION

The scope of the present invention is defined solely by the appended claims, and is not affected to any degree by the statements within this summary.

A first aspect of the present invention is a sample analyzer comprising: a plurality of measuring units for measuring samples and outputting measurement data; a transporting device for transporting samples to be measured to the respective measuring units; a data processor for processing the measurement data output from at least one of the measuring units; a connection state information obtainer for automatically obtaining connection state information relating to connection state of the measuring units; and a transport controller for controlling operation of the transporting device in accordance with the connection state information obtained by the connection state information obtainer.

A second aspect of the present invention is a sample measuring method executable by a sample analyzer comprising a plurality of measuring units for measuring a sample, and a transport device for transporting samples to be measured to the respective measuring devices, the method comprising: detecting connections of the measuring units; automatically obtaining connection state information relating to connection state of the connected measuring units based on detected results; controlling the transport device in accordance with the obtained connection state information; and measuring transported samples.

A third aspect of the present invention is a computer program product for a sample analyzer comprising a plurality of measuring units for measuring a sample, and a transport device for transporting samples to be measured to the respective measuring units, the computer program product comprising: a computer readable medium; and instructions, on the computer readable medium, adapted to enable a general purpose computer to perform operations, comprising: detecting connections of the measuring units; automatically obtaining connection state information relating to connection state of the connected measuring units based on detected results; controlling the transport device in accordance with the obtained connection state information; and measuring the transported sample.

### BRIEF DESCRIPTION OF THE DRAWINGS

FIG. 1 is a schematic view briefly showing the structure of a first embodiment of the sample analyzer of the present invention;

FIG. 2 is a perspective view showing the exterior of a sample container;

FIG. 3 is a perspective view showing the exterior of a sample rack;

FIG. 4 is a schematic view briefly showing the structure of a measuring unit and sample transporting device;

FIG. 5 is a block diagram showing the structure of the transport control device of the first embodiment of the present invention;

FIG. 6 is a block diagram showing an example of the structure in the case of a sample smear preparing device as a measuring unit;

FIG. 7 is a block diagram showing the structure of a measuring unit and control device of the sample analyzer of the first embodiment of the present invention;

FIG. 8 is a flow chart showing the sequence of the measuring unit adding process of the CPU of the transport control device and the CPU of the control device of the sample analyzer of the first embodiment of the present invention;

FIG. 9 is a flow chart showing the sequence of the sample measuring process of the CPU 81 of the transport control device 8 and the CPU 91 of the measurement control device 9 of the sample analyzer 1 of the first embodiment of the present invention;

FIG. 10 is a block diagram showing an example of a connection between a reagent container and a measuring unit;

FIG. 11 is a schematic view briefly showing the structure of a second embodiment of the sample analyzer of the present invention;

FIG. 12 is a block diagram showing the structure of a measuring unit and control device of the sample analyzer of the second embodiment of the present invention;

FIG. 13 is a flow chart showing the sequence of the measuring unit adding process of the CPU of the control device of the sample analyzer of the second embodiment of the present invention; and

FIG. 14 is a flow chart showing the sequence of the sample measuring process of the CPU 91 of the measurement control device 9 of the sample analyzer 1 of the second embodiment of the present invention.

### DETAILED DESCRIPTION OF THE PREFERRED EMBODIMENTS

The preferred embodiments of the present invention will be described hereinafter with reference to the drawings. The preferred embodiments are described below based on the drawings, and a sample analyzer for blood and the like connected to a plurality of types of measuring units is used in the example.

### First Embodiment

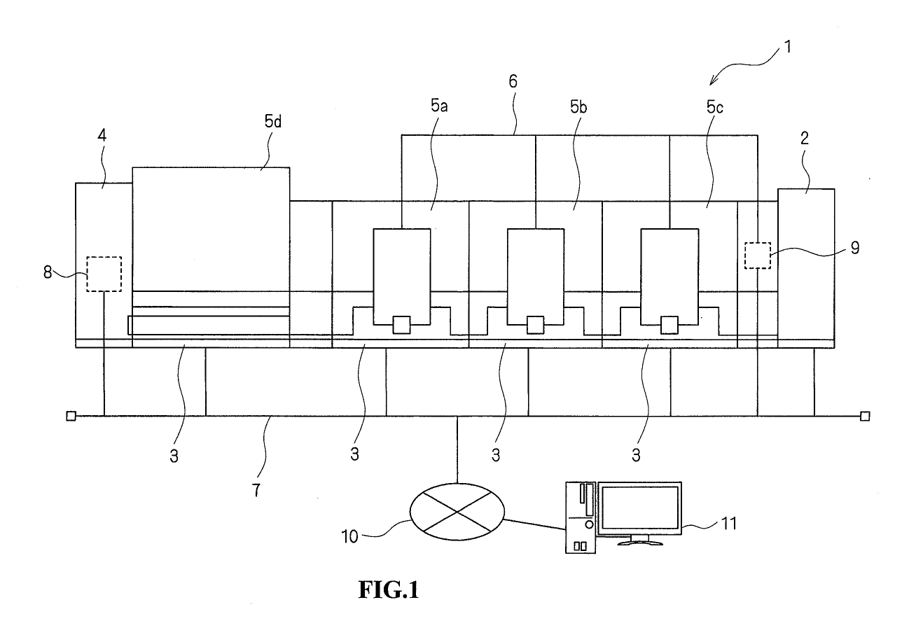

FIG. 1 is a schematic view briefly showing the structure of a first embodiment of the sample analyzer of the present invention. The sample analyzer 1 of the first embodiment of the present invention is provided with a sample delivery device 2 for delivering a sample rack holding a sample container, a plurality of measuring units (5a, 5b, 5c, 5d) for measuring a clinical sample of urine, blood or the like, sample transport devices (transport devices) 2 provided for every five measuring units for transporting samples, sample receiving device 4 for receiving a sample rack after sample collection, and a transport control device 8.

The plurality of measuring units 5 may be the same type of measuring unit, or may be a plurality of types of measuring units 5a, 5b, 5c, 5d. A prescribed number of measuring units 5 are connected as a group to the measurement control device 9 through a connection line 6. In the first embodiment, the measuring units 5 are connected to the measurement controller 9 in groups of three using a USB cable as the connection line 6.

The sample delivering device 2 is configured so as to deliver a sample rack holding a plurality of sample containers to the sample transport devices 3. The delivery of the sample rack is controlled by the transport control device 8 which is connected to the sample delivery device 2 via a LAN so as to be capable of data communication.

The transport control device 8 and the measurement control device 9 are connected via the LAN 7 so as to be capable of data communication, and control the sample rack in accordance with the connection state information related to the state of the connections of the measuring units 5 obtained by the measurement control device 9. The LAN 7 is also connected to a network 10, and the results of processing and analysis of the measurement data obtained by the measuring units 5 are displayed by an external operation and display device 11 connected to the network 10.

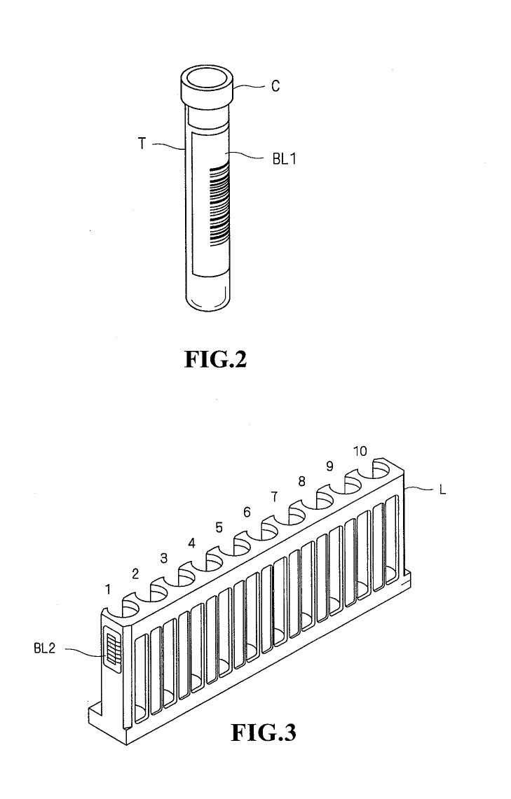

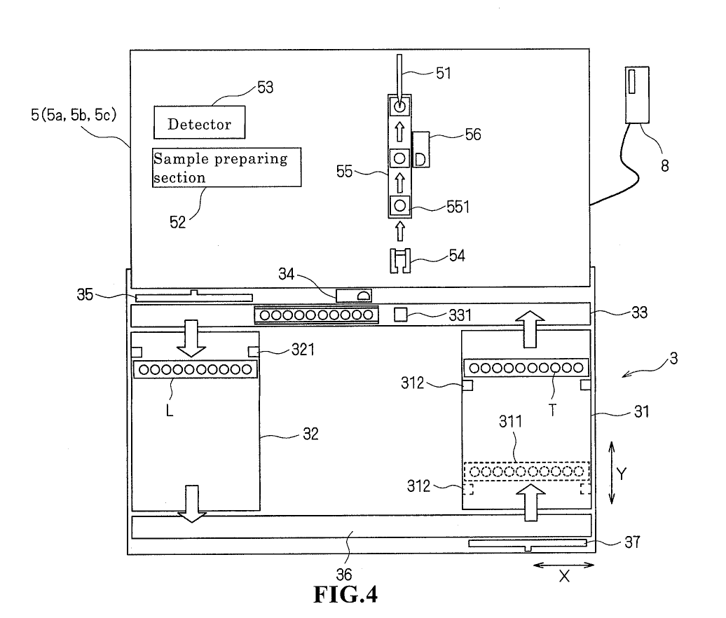

FIG. 2 is a perspective view showing the exterior of a sample container. FIG. 3 is a perspective view showing the exterior of a sample rack. As shown in FIG. 2, a sample container T is tube-like, and the top end is open. A sample, for example, blood collected from a patient, is contained within the sample container T, and the opening at the top end can be sealed by a cover C. A barcode label BL1 is adhered to the side surface of the sample container T, and a barcode identifying the sample is printed on the barcode label. As shown in FIG. 3, a sample rack L is configured so as to hold ten sample containers T in a vertical condition (upright state). A barcode label BL2 is adhered to the side surface of the sample rack L, and a barcode identifying the sample rack L is printed on the barcode label.

The sample analyzer 1 shown in the example of FIG. 1 has four sample transporting devices 3 disposed at the front (towards the bottom of FIG. 1) of the four measuring units 5a, 5b, 5c, 5d. A sample rack L is delivered between the adjacent sample transporting devices 3. The rightmost (to the right side in FIG. 1) sample transporting device 3 starts transporting the sample rack L delivered from the sample delivery device 2. The leftmost (to the left side in FIG. 1) sample transporting device 3 transports the sample rack L to the sample receiving device 4.

FIG. 4 is a schematic view briefly showing the structure of the measuring unit 5 and sample transporting device 3. As shown in FIG. 4, the sample transporting device 3 is provided with a pre-analysis rack holder 31 for temporarily holding a plurality of sample racks L supporting sample containers T containing unmeasured samples, post-analysis rack holder 32, rack conveyor 33 for linearly moving the sample rack L in the arrow X direction, barcode reader 34 for reading the barcodes, rack mover 35 for moving the sample rack L to the post-analysis rack holder 32, rack mover 36 for moving the sample rack L in the arrow X direction, and rack mover 37 for moving the sample rack L to the pre-analysis holder 31.

The sample rack L is moved to the pre-analysis rack holder 31 by the movement of the rack mover 37 in the arrow Y direction. When the moved sample rack L is positioned at a rack detection position 311, the sample rack L is engaged by extending a rack taker 312 toward the inner side from both side surfaces of the pre-analysis rack holder 31. The rack taker 312 moves the engaged sample rack L to near the rack conveyor 33 in conjunction with the movement toward the rack conveyor 33. Note that the position of the sample rack L may be detected by a sensor (not shown in the drawing).

The rack conveyor 33 transports the sample rack L, which has been delivered by the pre-analysis rack holder 31, in the X direction (from right to left in FIG. 4). The sample container T transported to a sample supplying position 331 is picked up by the holder of the measuring unit 5, and the sample container T is removed from the sample rack L whereupon the sample is aspirated and supplied to the measuring unit 5, then the sample container T is returned to the sample rack L.

The rack mover 35 is disposed so as to face the post-analysis rack holder 32 with the rack conveyor 33 interposed therebetween, and moves linearly in the arrow Y direction. The sample rack L is moved from the rack conveyor 33 to the post-analysis rack holder 32 by the movement of the rack mover 35 in the arrow Y direction. When the sample rack L has been moved, the sample rack L is engaged by projecting the rack taker 321 from both side surfaces of the post-analysis rack holder 32 toward the inner side. The engaged sample rack L is moved to near the rack mover 36 in conjunction with the movement of the rack taker 321 to near the rack mover 36.

The sample receiving device 4 can hold a plurality of sample racks L. After sample aspiration has ended, the sample rack L supporting the sample container T in the measuring units 5 is transported by the sample transporting device 3 and received by the sample receiving device 4.

Transporting the sample rack L by the sample transporting device 3 is controlled by the transport control device 8 which is connected to the sample transporting device 3 via a LAN 7 to as to be capable of data communication. That is, the transport control device 8 controls the transporting of the sample rack L by the sample transporting device 3 from the delivery by the sample delivery device 2, and the receiving of the sample rack L from the sample transporting device 3 by the sample receiving device 4. Note that the synchronous operations of the sample transporting devices 3 and measuring units 5 are pursuant to the instructions of the externally connected operation and display device 11 as the sample analyzer 1.

Note that the sample transporting devices 3 and sample receiving device 4 may also be provided with controllers respectively connected to the transport control device 8 and measurement control device 9 so as to be capable of data communication. In this case, the transport control device 8 executes controls instruct each controller to determine to which measuring unit to transport the sample rack L and by which route, and each controller controls the transport of the sample rack L in accordance with the determined route.

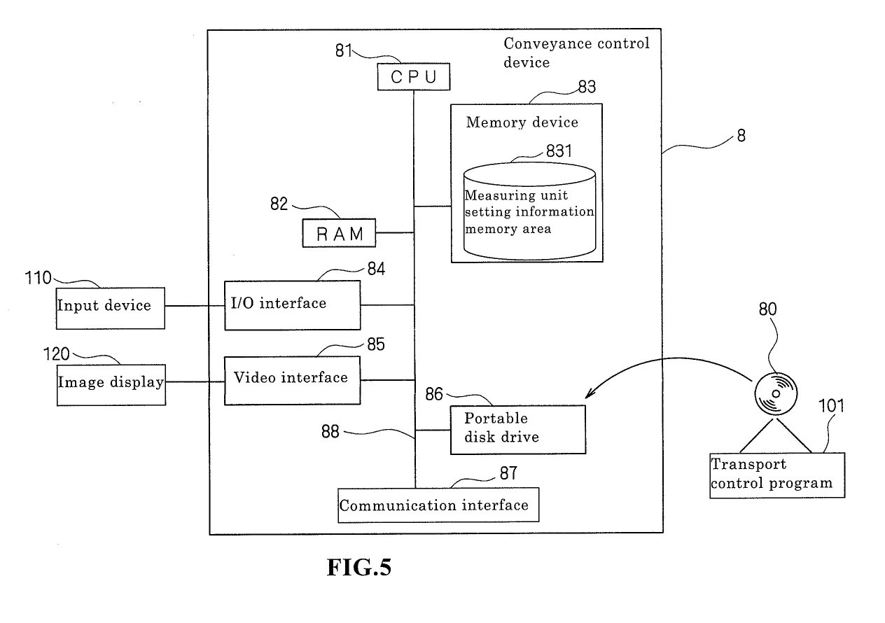

FIG. 5 is a block diagram showing the structure of the transport control device 8 of the first embodiment of the present invention. As shown in FIG. 5, the transport control device 8 is configured by a CPU 81, RAM 82, memory device 83, input/output (I/O) interface 84, video interface 85, portable disk drive 86, communication interface 87, and an internal bus 88 connected all these hardware.

The CPU 81 is connected to each hardware part of the transport control device 8 through the internal bus 88, and controls the operations of the hardware devices and executes various software functions in accordance with a transport control program 101 stored in the memory device 83. The RAM 82 is configured by a volatile memory such as SRAM, SDRAM or the like, and develops loaded modules when the transport control program 101 is executed, and stores temporary data generated during the execution of the transport control program 101.

The memory device 88 is configured by a ROM or internal fixed storage device (hard disk) or the like. The transport control program 101 stored in the memory device 83 is downloaded by the portable disk drive 86 from a portable recording medium 80 such as a DVD, CD-ROM or the like which records the program and data, and developed from the memory device 83 to the RAM 82 during execution. Of course, the computer programs may also be downloaded from an external computer connected to the network via the communication interface 87.

The memory device 83 is provided with a measuring unit setting information memory area 831 for storing setting information corresponding to the type of detachable measuring unit 5. When the connection state information of the measuring units 5 is obtained from the measurement control device 9, the transport controls are executed in accordance with the connection state information.

The model names of the connected measuring units 5 and the connection sequence of the measuring units 5 are associated with the setting information of the transport control program 101 and all data are stored in the measuring unit setting information memory area 831. The priority information indicating the priority of transporting a sample rack L to a measuring unit 5, and re-examination device information indicating to which measuring unit 5 to transport a sample requiring re-examination are stored as setting information of the transport control program 101. Note that when the present invention is applied to a sample analyzer 1 capable of being connected to only the same type of measuring unit 5, the number of connections of the measuring units 5 may be associated with the setting information of the transport control program 101 and stored in the measuring unit setting information memory area 831.

The communication interface 87 is connected to the internal bus 88, and is capable of sending and receiving data to/from external computers via a connection to an external network such as a LAN, WAN, the Internet or the like. In the first embodiment, the measurement control device 9 and sample transporting devices 3 are connected via the LAN 7. The operation and display device 11 may also be connected to the network 10 so as to be capable of sending and receiving data.

The I/O interface 84 is connected to an input device 110 such as a keyboard, mouse, or the like, and is capable of receiving data input. The video interface 85 is connected to an image display unit 120 such as a CRT monitor, LCD or the like to display predetermined images.

The plurality of measuring units 5 may be the same type or different types of measuring unit. Although two measuring units 5a and 5c are the same type of measuring unit in the example of FIG. 1, the remaining measuring units 5b and 5d are different types of measuring units. Specifically, the measuring units 5a and 5c are blood cell analyzers; for example, the measuring unit 5a performs blood cell counts by an electrical resistance method, and measuring unit 5c performs blood cell counts by an optical method, and prepare scattergrams with color-differentiated blood cell types that are then displayed. The measuring unit 5b is a hemoglobin concentration measuring unit of measuring the concentration of hemoglobin A1c (HgbA1c) in a blood sample, and the measuring unit 5d is a sample smear preparing unit for preparing a sample smear. U.S. Pat. No. 6,268,208 and U.S. Patent Application No. 2006-0250604 are hereby incorporated by reference in their entirety as though fully and completely set forth herein.

FIG. 4 briefly shows the structure when the measuring unit 5 is a blood cell analyzer or hemoglobin concentration measuring unit (measuring units 5a, 5b, 5c). The measuring unit 5 has a sample aspirator 51 for aspirating a blood sample from a sample container T, a sample container transporter 55 for transporting the sample container T to the aspirating position, barcode reader 56, sample preparing unit 52 for preparing a measuring sample using the aspirated blood to be used for measurements, and a detector 53 for detecting the number of blood cells from the prepared measurement sample.

The sample container transporter 55 is provided with a gripper 54 for gripping a sample container T, and a sample container acceptor 551 which has a hole for inserting a sample container T. In the sample container transporter 55, the sample container T, which is positioned at a sample supplying position 331 and held in a sample rack L, is gripped by the gripper 54 and moved in the arrow Y direction, and the sample container T is inserted into the hole of the sample container acceptor 551. The sample container acceptor 551 moves and the barcode reader 56 reads the barcode, and the sample is aspirated from the sample container T by the sample aspirator 51.

In the sample preparing unit 52, a measurement sample is prepared by adding supplied reagent to the sample aspirated from the sample container T. When, for example, detecting WBC (detecting white blood cells), the detector 53 detects the white blood cells by irradiating laser light on the prepared measurement sample using flow cytometry. The detection results are transmitted to the measurement control device 9 as electrical data.

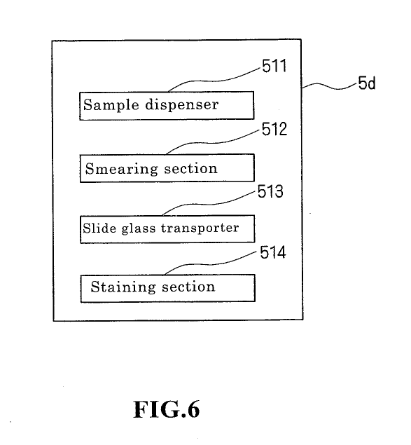

FIG. 6 is a block diagram showing an example of the structure in the case of a sample smear preparing device as the measuring unit 5. As shown in FIG. 6, the measuring unit 5d which is used as a sample smear preparing unit is provided with a sample dispenser 511, smearing unit 512, slide glass transporter 513, and staining unit 514.

The sample dispenser 511 has the same structure as the sample aspirator 51 and sample container transporter 55 shown in FIG. 4, and is configured so as to drip the blood sample aspirated from the sample container T onto a slide glass using an aspirating tube (not shown in the drawing) equivalent to the sample aspirator 51. The smearing unit 512 smears and dries the blood sample dripped on the slide glass, and prints the identifying information on the slide glass.

The slide glass transporter 513 holds the slide glass with the smeared blood sample in a transport cassette. The staining unit 514 supplies a liquid stain to the slide glass held in the cassette and transported to a staining position. The smear sample prepared by smearing and staining is processed in a blood cell image display device (not shown in the drawing). Sample detection therefore can not be performed by the measuring unit 5d which prepared the smear sample. Note that the type of measuring unit 5 is not limited to those named, and may of course be a urine analyzer, blood coagulation measuring device, immunoanalyzer, gene amplification measuring device and the like.

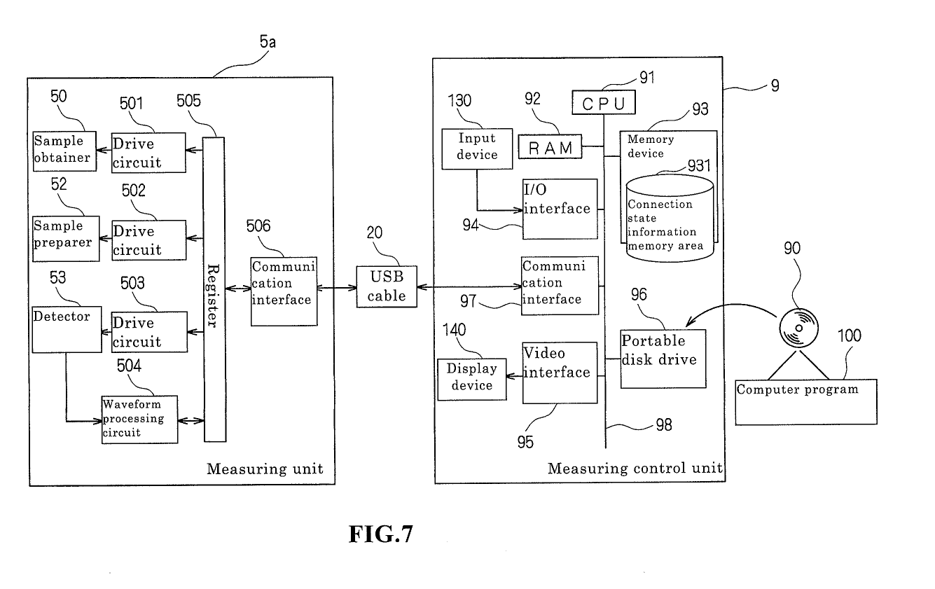

FIG. 7 is a block diagram showing the structure of the measuring unit 9 and the measuring unit 5 of the sample analyzer 1 of the first embodiment of the present invention. FIG. 7 shows an example of the structure of the measuring unit 5 in the form of a blood cell analyzer. As shown in FIG. 7, the measuring unit 5 (5a) is provided with a sample obtainer 50, drive circuit 501 for driving the sample obtainer 50, sample preparing unit 52, drive circuit 502 for driving the sample preparer 52, detector 53, drive circuit 503 for driving the detector 53, and a waveform processing circuit 504 for performing waveform processing of the electrical signals output from the detector 53.

The sample obtainer 50 and sample preparing unit 52 are respectively driven by the drive circuit 501 and drive circuit 502 which output control signals corresponding to the control data stored in a register 505. The detector 53, for example, converts obtained optical signals to electrical signals, and the waveform processing circuit 504 amplifies the converted and transmitted electrical signals then performs waveform processing of the amplified electrical signals. The register 505 stores the waveform-processed electrical signals.

A communication interface 506 is a USB serial interface connected to the communication interface 97 of the measurement control device 9 via a USB cable 20. Therefore, when connected via the USB cable 20, the measurement control device 9 obtains information relating to the connected measuring unit 5 (5a).

The measurement control device 9 is configured by a CPU 91, RAM 92, memory 93, I/O interface 94, video interface 95, portable disk drive 96, communication interface 97, and an internal bus 98 connecting all the hardware.

The CPU 91 is connected to each hardware part of the measurement control device 9 through the internal bus 98, and controls the operations of the hardware devices and executes various software functions in accordance with a computer program 100 stored in the memory device 93. The RAM 92 is configured by a volatile memory such as SRAM, SDRAM or the like, and develops loaded modules when the computer program 100 is executed, and stores temporary data generated during the execution of the transport control program 100.

The memory device 93 is configured by a ROM or internal fixed storage device (hard disk) or the like. The computer program 100 stored in the memory device 93 is downloaded by the portable disk drive 96 from a portable recording medium 90 such as a DVD, CD-ROM or the like which records the program and data, and developed from the memory device 93 to the RAM 92 during execution. Of course, the computer program may also be downloaded from an external computer connected to the network via the communication interface 97.

The memory device 93 is provided with a connection state information memory area 931 for storing connection state information including the sequential connections of the various types of measuring units 5. The connection state information of the measuring units 5 stored in the connection state information memory area 931 is transmitted to the transport control device 8 as needed.

The communication interface 97 is connected to the internal bus 98, and is capable of sending and receiving data to/from external computers via a connection to an external network such as a LAN, WAN, the Internet or the like. In the first embodiment, the transport control device 8 and sample transporting devices 3 are connected via the LAN 7. The operation and display device 11 is connected to the network 10 so as to be capable of sending and receiving data.

The I/O interface 94 is connected to an input device 130 such as a keyboard, mouse, or the like, and is capable of receiving data input. The video interface 95 is connected to an image display unit 140 such as a CRT monitor, LCD or the like to display predetermined images.

In the sample analyzer 1 of the first embodiment, when a plurality of measuring units 5 are connected, the measurement control device 9 obtains the connection state information relating to the connection states of the measuring units 5 connected via the connection line 6, and stores the connection state information in the connection state information memory area 931 of the memory device 93. The transport control device 8 obtains the connection state information from the connection state information memory area 931, and transmits control signals instructing the operation of the sample transporting devices 3.

For example, when a new measuring unit 5 is added, the measurement control device 9 obtains the identification information (serial number, model name and the like) of the new measuring unit 5, and obtains the port number of the measuring unit 5 connected to the measurement control device 9. The connection sequence information of the measuring units 5 including the new measuring unit 5 can also be obtained in this manner.

The transport control device 8 obtains the connection state information from the measurement control device 9, specifies the sample to be sent to the new measuring unit 5, an updates the setting information of the transport control program 101 so as to have the sample transporting device 3 transport the sample rack L holding the sample container T corresponding to this sample to the new measuring unit 5.

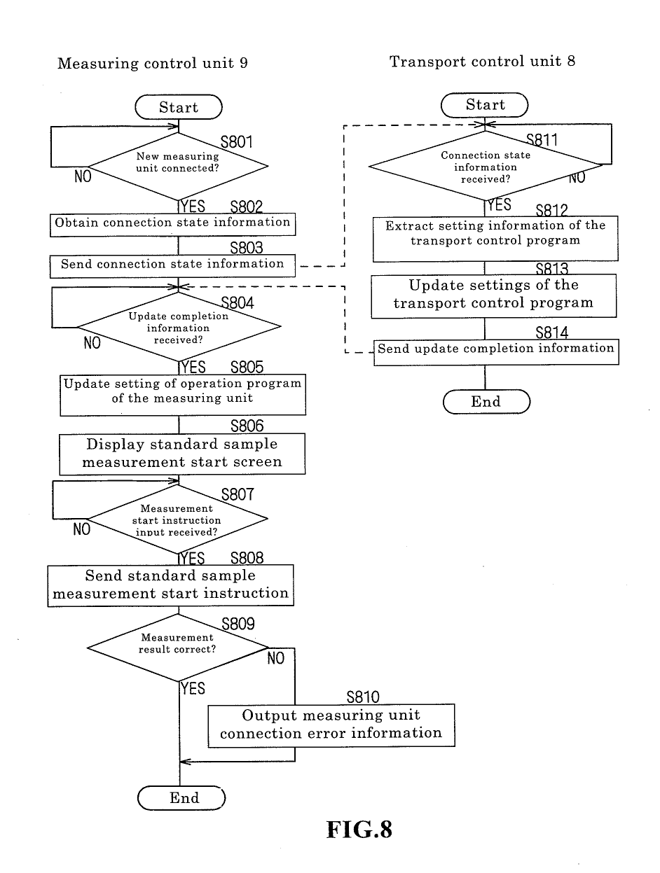

An example of the processing when a new measuring unit 5 has been added is described below. FIG. 8 is a flow chart showing the sequence of the measuring unit adding process of the CPU 81 of the transport control device 8 and the CPU 91 of the measurement control device 9 of the sample analyzer 1 of the first embodiment of the present invention.

In FIG. 8, the CPU 91 of the measurement control device 9 of the sample analyzer 1 of the first embodiment determines whether a new measuring unit 5 is connected (step S801). Specifically, the determination is made by reception of hardware identification information via the USB connection, or reception of a response signal to a transmission of a periodic confirmation signal through the LAN 7.

When the CPU 91 has determined that a new measuring unit 5 is not connected (step S801: NO), the CPU 91 enters a standby state. When the CPU 91 has determined that a new measuring unit 5 is connected, that is, the connection of the new measuring unit 5 is detected (step S801: YES), the CPU 91 obtains the connection state information (step S802), and stores the information in the connection state information memory area 931 of the memory device 93.

Information relating to the number of connected measuring units 5 and types of connected measuring units 5 are included as the obtained connection state information. The setting information of the measuring unit 5 is stored in the measuring unit setting information memory area 831 of the memory device 83 by the transport control device 8 based on the information relating to the type of measuring unit 5.

Of course, the obtained connection state information is not limited to the examples described above, and may be, for example, measurement item information relating to the items which are measurable by each measuring unit 5, or connection sequence information relating to the connection sequence of a plurality of measuring units 5. The items to be set by the measurement item information can be specified, and information relating to the transporting sequence of the sample racks L can be properly obtained by the connection sequence information.

The connection sequence information of the measuring units 5 may also be obtained by the differences of the USB cables 20 connected to the measuring units 5. Specifically, the measurement control device 9 and measuring units 5 may be connected by USB cables having lengths that match the distances between the measurement control device 9 and the connected measuring units 5. In this case, the length of the USB cable 20 is a length equal to the distance between the measurement control device 9 and a specific measuring unit 5. Therefore, another measuring unit 5 which is more distance from the position of the measurement control device 9 than the specific measuring unit 5 can not be physically connected due to the insufficient length of the USB cable 20. Connection errors can thus be prevented before they occur.

The CPU 91 transmits the obtained connection state information to the transport control device 8 (step S803). The CPU 81 of the transport control device 8 determines whether the connection state information has been received from the measurement control device 9 (step S811). When the CPU 81 has determined that the connection state information has not been received (step S811: NO), the CPU 81 enters the reception standby state.

When the CPU 81 has determined that the connection state information has been received (step S811: YES), the CPU 81 extracts the setting information of the transport control program 101 (step S812), updates the settings of the transport control program 101 (step S813), and transmits the update completion information indicating the setting updates have been completed to the measurement control device 9 (step S914).

For example, the CPU 81 extracts the previously mentioned priority information and re-examination device information from the measuring unit setting information memory area 831 according to the model name and connection sequence of the measuring units included in the received connection state information, and updates the settings of the transport control program 101 based on the extracted priority information and re-examination device information. The transport control program 101 can thus execute the optimum transport controls to be performed by the transport control device 8 according to the type and sequence of the connected measuring units 5.

The measurement control device 9 determines whether the update completion information has been received from the transport control device 8 (step S804). When the CPU 91 has determined that the update completion information has not been received (step S804: NO), the CPU 91 enters the reception standby state. When the CPU 91 has determined that the update completion information has been received (step S804: YES), the CPU 91 updates the settings of the operation programs for the measuring units 5 (step S805). Specifically, the settings are updated for the connection sequence and the like of the measuring units 5 connected to a single measurement control device 9.

The CPI 91 displays the standard sample measurement start screen on the display 140 which is the determination standard of whether the new measuring unit 5 is operating properly (step S806), and determines whether the measurement start instruction input has been received (step S807). When the CPU 91 determines that the measurement start instruction input has not been received (step S807: NO), the CPU 91 enters the input reception standby state.

When the CPU 91 determines that the measurement start instruction input has been received (step S807: YES), the CPU 91 sends the standard sample measurement start instruction to the newly connected measuring unit 5 (step S808), and determines whether the measurement result is accurate (step S809). The methods for determining whether the measurement result is accurate are not specifically limited insofar as the methods will differ depending on the type of the measuring unit 5. However, it is desirable that the determination is made by comparing the obtained measurement result with measurement results of standard samples which have been previously stored in memory.

When the CPU 91 determines that the measurement result in inaccurate (step S809: NO), the CPU 91 outputs connection error information indicating that a connection error has occurred relative to the measuring unit 5 (step S810). When the CPU 91 determines that the measurement result is accurate (step S809: YES), the CPU 91 ends the process.

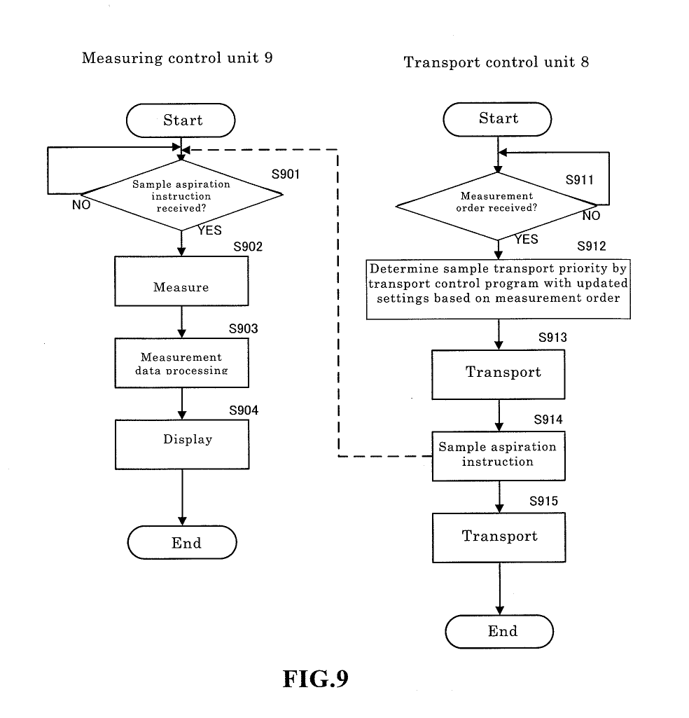

FIG. 9 is a flow chart showing the sequence of the sample measuring process of the CPU 81 of the transport control device 8 and the CPU 91 of the measurement control device 9 of the sample analyzer 1 of the first embodiment of the present invention. The sample measuring process is executed after the execution of the measuring unit adding process shown in FIG. 8.

In FIG. 9, the CPU 81 of the transport control device 8 of the sample analyzer 1 of the first embodiment determines whether a measurement order has been received from the operation and display device 11 (step S911). The measurement order includes information indicating the measurement items that must be measured. When the CPU 81 determines that a measurement order has not been received (step S911: NO), the CPU 81 enters the standby state. When the CPU 81 determines that a measurement order has been received (step S911: YES), the CPU 81 then determines the sample transport destination from among the plurality of measuring units by the transport control program with the settings updated in step S813 (refer to FIG. 8) based on the received measurement order (step S912). The CPU 81 executes a process of transporting the sample to the determined transport destination (measuring unit) (step S913). When the sample arrives at the measuring unit, the CPU 81 sends a sample aspiration instruction to the CPU 91 of the measurement control device 9 (step S914). After the sample has been aspirated by the measuring unit, the CPU 81 executes a process of transporting the sample to the recovery position (step S915).

On the other hand, the CPU 91 of the measurement control device 9 determines whether the sample aspiration instruction has been received from the CPU 81 of the transport control device 8 (step S901). When the CPU 91 determines that a sample aspiration instruction has not been received (step S901: NO), the CPU 91 enters the standby state. When the CPU 91 determines that the sample aspiration instruction has been received (step S901: YES), the measuring unit executes the sample measuring process (step S902). When the measuring unit measure a sample and outputs measurement data, the CPU 91 analyzes the measurement data and obtains a sample analysis result (step S903). The CPU 91 then displays the obtained sample analysis result on the display 140 (step S904).

Note that many kinds of reagent are used with the measuring units 5, and that normally a plurality of reagent containers T are connected to one measuring unit 5. When newly connecting or replacing a measuring unit, the plurality of reagent containers T must be properly connected. In the first embodiment, connectors/receptacles are used which can be connected in a batch so as to reduce even slightly the complex work.

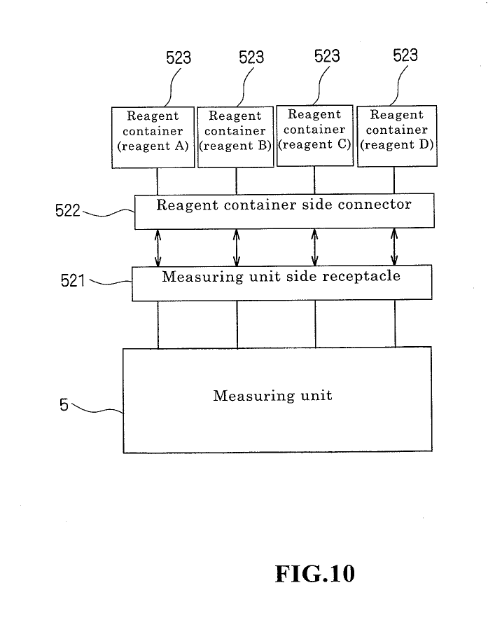

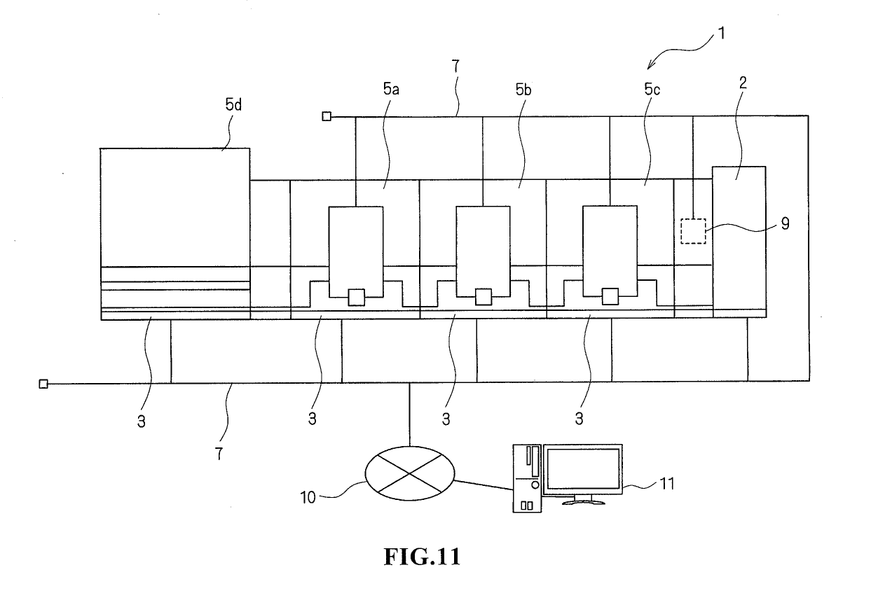

FIG. 10 is a block diagram showing an example of the connection of the measuring unit 5 and the reagent container T. The measuring unit 5 is provided with a receptacle 521 for connecting to a reagent container connector 522 provided on the reagent container side. The reagent connector side connector 522 can be mounted on a plurality of reagent containers 523. The reagents held in the reagent containers 523 can be supplied so that the proper reagent is supplied to the proper sample without supplying the wrong reagent to the wrong sample by connecting the reagent side connector 522 and the measuring unit side receptacle 521.

Since connection state information which includes the number of connections of measuring units can be reliably obtained when a measuring unit is installed and detached in the first embodiment described above, a user can be reassured, for example, when replacing a measuring unit because the position, number and type of the newly connected measuring unit can be accurately managed without requiring an expert operator. Therefore, a specialist need not be dispatched to the site, and an increase of maintenance costs are reduced before they occur.

### Second Embodiment

FIG. 11 is a schematic view briefly showing the structure of a sample analyzer 1 of a second embodiment of the present invention. The brief structure of the sample analyzer 1 of the second embodiment of the present invention is identical to that of the first embodiment with the exception that the transport control device 8 is not provided and differs from the first embodiment in that all measuring units 5 are connected by the LAN 7. Note that parts of the structure which are identical to those of the first embodiment will be identified by the same reference numbers as in the first embodiment and their detailed description will be omitted.

The plurality of measuring units 5 may be the same type of measuring unit, or may be a plurality of types of measuring units 5a, 5b, 5c, 5d. The measuring units 5 are connected to a single measurement control device 9 via the LAN 7.

The sample delivering device 2 is configured so as to deliver a sample rack holding a plurality of sample containers to the sample transport devices 3. The transporting of the sample rack L is controlled by the measurement control device 9 which is connected to the sample delivery device 2 via the LAN 7 so as to be capable of data communication, and the transporting of the sample rack L is controlled according to the connection state information relating to the connection state of the measuring units 5 obtained by the measurement control device 9. The LAN 7 is also connected to a network 10, and the results of processing and analysis of the measurement data obtained by the measuring units 5 are displayed by an external operation and display device 11 connected to the network 10.

Since the brief structures of the measuring unit 5 and the sample transporting device 3 are identical to those of the first embodiment, their structures will not be described in detail below. Transporting the sample rack L by the sample transporting device 3 is controlled by the measurement control device 9 which is connected to the sample transporting device 3 via a LAN 7 to as to be capable of data communication. That is, the measurement control device 9 controls the transport of the sample rack L from the arrival at sample delivery device 2 by the sample transporting device 3, and the reception from the sample transporting device 3 to the sample receiving device 4. Note that the synchronous operation of the sample transporting devices 3 and the measuring devices 5 as the sample analyzer 1 is performed in accordance with instructions of the externally connected operation and display device 11.

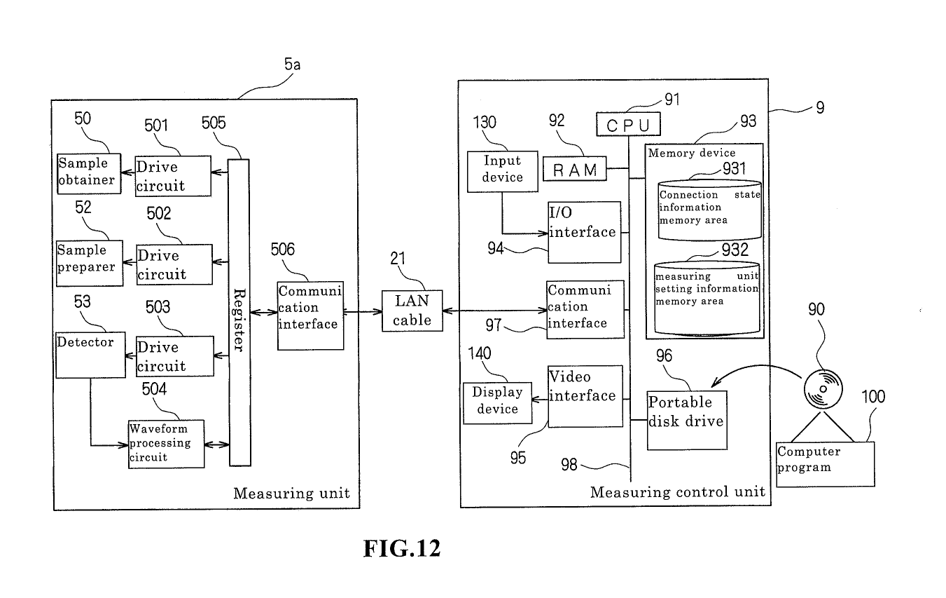

FIG. 12 is a block diagram showing the structure of the measuring unit 9 and the measuring unit 5 of the sample analyzer 1 of the second embodiment of the present invention. FIG. 12 shows an example of the structure of the measuring unit 5a in the form of a blood cell analyzer. As shown in FIG. 11, the measuring unit 5 (5a) is provided with a sample obtainer 50, drive circuit 501 for driving the sample obtainer 50, sample preparing unit 52, drive circuit 502 for driving the sample preparer 52, detector 53, drive circuit 503 for driving the detector 53, and a waveform processing circuit 504 for performing waveform processing of the electrical signals output from the detector 53.

The sample obtainer 50 and sample preparing unit 52 are respectively driven by the drive circuit 501 and drive circuit 502 which output control signals corresponding to the control data stored in a register 505. The detector 53, for example, converts obtained optical signals to electrical signals, and the waveform processing circuit 504 amplifies the converted and transmitted electrical signals then performs waveform processing of the amplified electrical signals. The register 505 stores the waveform-processed electrical signals.

The communication interface 506 is a LAN interface connected to the communication interface of the measurement control device 9 via a LAN cable 21. The measurement control device 9 transmits a confirmation signal that confirms that the connection state information has been periodically updated to all devices connected to the LAN 7 to obtain information relating to the connected measuring units 5 (5a).

The measurement control device 9 is configured by a CPU 91, RAM 92, memory 93, I/O interface 94, video interface 95, portable disk drive 96, communication interface 97, and an internal bus 98 connecting all the hardware, and the structure is identical to that of the first embodiment.

The memory device 93 is provided with a connection state information memory area 931 for storing the connection state information which includes the sequences of the connections to the various types of measuring units 5, and a measuring unit setting information memory area 932 for storing the set item information corresponding to the type of measuring unit 5 that is removable. When the connection state information of the measuring units 5 is obtained, the operations of the sample transporting devices 3 are controlled according to the connection state.

The communication interface 97 is connected to the internal bus 98, and is capable of sending and receiving data to/from external computers via a connection to an external network such as a LAN, WAN, the Internet or the like. In the second embodiment, the sample transporting devices 3 are connected by the LAN 7. The operation and display device 11 is connected to the network 10 so as to be capable of sending and receiving data.

In the sample analyzer 1 of the second embodiment, when the plurality of measuring units 5 are removable, the measurement control device 9 obtains the connection state information relating to the connection state of the measuring units 5 connected via the LAN 7, and stores the information in the connection state information memory area 931 of the memory device 93. The measurement control device 9 obtains the connection state information from the connection state information memory area 931, and transmits control signals instructing the operation of the sample transporting devices 3.

For example, when a new measuring unit 5 is added, the measurement control device 9 obtains the identification information (serial number, model name and the like) of the new measuring unit 5, and obtains the port number of the measuring unit 5 connected to the measurement control device 9. The connection sequence information of the measuring units 5 including the new measuring unit 5 can also be obtained in this manner.

The measurement control device 9 specifies the sample to be transported to the measuring unit 5 to be measured by the new measuring unit 5 based on the obtained connection state information, and updates the setting information of the transport control program which includes the computer program 100 so as to transport the sample rack L holding the sample container T corresponding to the sample to the new measuring unit 5 via the sample transporting device 3.

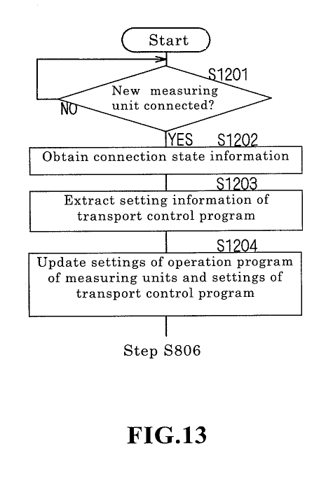

An example of the processing when a new measuring unit 5 has been added is described below. FIG. 13 is a flow chart showing the sequence of the measuring unit adding process of the CPU 91 of the measurement control device 9 of the sample analyzer 1 of the second embodiment of the present invention.

In FIG. 13, the CPU 91 of the measurement control device 9 of the sample analyzer 1 of the second embodiment determines whether a new measuring unit 5 is connected (step S1201). Specifically, the determination is made by the reception of a response signal to the transmission of a periodic confirmation signal send via the LAN 7.

When the CPU 91 has determined that a new measuring unit 5 is not connected (step S1201: NO), the CPU 91 enters a standby state. When the CPU 91 determines that a new measuring unit 5 is connected (step S1201: YES), the CPU 91 obtains the connection state information (step S1202), and stores the information in the connection state information memory area 931 of the memory device 93.

Information relating to the number of connected measuring units 5 and types of connected measuring units 5 may be included as the obtained connection state information. The setting information of the measuring unit 5 is stored in the measuring unit setting information memory area 932 of the memory device 93 by the measurement control device 9 based on the information relating to the type of measuring unit 5.

Of course, the obtained connection state information is not limited to the examples described above, and may be, for example, measurement item information relating to the items which are measurable by each measuring unit 5, or connection sequence information relating to the connection sequence of a plurality of measuring units 5. The items to be set by the measurement item information can be specified, and information relating to the transporting sequence of the sample racks L can be properly obtained by the connection sequence information.

The connection sequence information of the measuring units 5 may also be obtained by the difference of the LAN cables 21 connected to the measuring units 5. Specifically, the measurement control device 9 and measuring units 5 may be connected by LAN cables 21 having lengths that match the distances between the measurement control device 9 and the connected measuring units 5. In this case, the length of the LAN cable 21 is a length equal to the distance between the measurement control device 9 and a specific measuring unit 5. Therefore, another measuring unit 5 which is more distance from the position of the measurement control device 9 than the specific measuring unit 5 can not be physically connected due to the insufficient length of the LAN cable 21. Connection errors can thus be prevented before they occur.

The CPU 91 extracts the setting information of the transport control program included in the computer program 100 based on the obtained connection state information (step S1203), and updates the settings of the transport control program and the settings of the operation programs of the measuring units 5. Specifically, the settings are updated for the connection sequence information relating to the connection sequence of the measuring units 5 connected to a single measurement control device 9. The CPU 91 continues the process to the process of step S806.

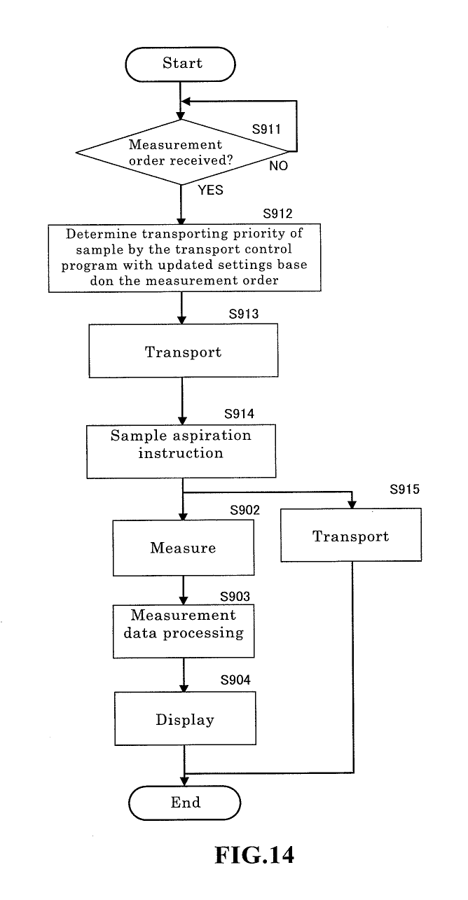

FIG. 14 is a flow chart showing the sequence of the sample measuring process of the CPU 91 of the measurement control device 9 of the sample analyzer 1 of the second embodiment of the present invention. The sample measuring process is executed after the execution of the measuring unit adding process shown in FIG. 13.

In FIG. 14, the CPU 91 of the measurement control device 9 of the sample analyzer 1 of the second embodiment determines whether a measurement order has been received from the operation and display device 11 (step S911). The measurement order includes information indicating the measurement items that must be measured. When the CPU 91 determines that the measurement order has not been received (step S911: NO), the CPU 91 enters the standby state. When the CPU 91 determines that a measurement order has been received (step S911: YES), the CPU 91 then determines the sample transport destination from among the plurality of measuring units by the transport control program with the settings updated in step S1204 (refer to FIG. 13) based on the received measurement order (step S912). The CPU 91 executes a process of transporting the sample to the determined transport destination (measuring unit) (step S913). When the sample reaches the measuring unit, the CPU 91 transmits a sample aspiration instruction to the measuring unit 5 (step S914). After the sample has been aspirated by the measuring unit, the CPU 91 executes a process of transporting the sample to the recovery position (step S915).

On the other hand, the CPU 91 executes a sample measurement process via the measuring unit 5 in parallel with the transporting of the sample to the recovery position (step S902). When the measuring unit measure a sample and outputs measurement data, the CPU 91 analyzes the measurement data and obtains a sample analysis result (step S903). The CPU 91 then displays the obtained sample analysis result on the display 140 (step S904).

Since connection state information which includes the number of connections of measuring units can be reliably obtained when a measuring unit is installed and detached in the second embodiment described above, a user can be reassured, for example, when replacing a measuring unit because the position, number and type of the newly connected measuring unit can be accurately managed without requiring an expert operator. Therefore, a specialist need not be dispatched to the site, and an increase of maintenance costs are reduced before they occur. Furthermore, the additional communication load in the LAN is reduced because data communication is unnecessary between control devices.

The present invention is not limited to the first and second embodiments inasmuch as the invention may be variously modified and transposed insofar as such modifications do not depart from the scope of the invention. For example, a plurality of transport control devices 8 and measurement control devices 9 may be provided, and the network structure is not particularly limited. Needless to say, a single control computer provided with the combined functions of the transport control device 8 and the measurement control device 9 may also be used.

What is claimed is:

1. A sample analyzer comprising:
a plurality of measuring units for measuring samples and outputting measurement data;
a transporting device for transporting samples to be measured to the respective measuring units;
a data processor for processing the measurement data output from at least one of the measuring units;
a connection state information obtainer for automatically obtaining connection state information relating to connection state of the measuring units; and
a transport controller for controlling operation of the transporting device in accordance with the connection state information obtained by the connection state information obtainer.

2. The sample analyzer according to claim 1 further comprising a program memory for storing a transport control program for controlling the operation of the transporting device; and
a setting updater for updating settings of the transport control program based on the connection state information obtained by the connection state information obtainer; wherein
the transport controller is configured to control the operation of the transporting device by the transport control program with the settings updated by the setting updater.

3. The sample analyzer according to claim 1 further comprising a measurement control device connected to the measuring units through a connection line so as to be capable of data communication; wherein
the measurement control device functions as a data processor and connection state information obtainer.

4. The sample analyzer according to claim 3 further comprising a transport control device connected to the transporting device so as to be capable of data communication; wherein
the transport control device functions as the transport controller.

5. The sample analyzer according to claim 4, wherein the measurement control device transmits the connection state information obtained by the connection state information obtainer to the transport control device; and
the transport control device receives the connection state information transmitted from the measurement control device.

6. The sample analyzer according to claim 1, wherein the connection state information obtainer obtains type information, as the connection state information, relating to types of each measuring unit and a number of connections of the measuring units;
the transport controller controls the operation of the transport device in accordance with the type information of each measuring unit and the number of connections of the measuring units.

7. The sample analyzer according to claim 1, wherein the connection state information obtainer obtains measurement item information, as the connection state information, relating to measurable items of each measuring unit and a number of connections of the measuring units; and
the transport controller controls the operation of the transport device in accordance with the measurement item information of each measuring unit and the number of connections of the measuring units.

8. The sample analyzer according to claim 1, wherein the connection state information obtainer obtains connection sequence information, as the connection state information, relating to connection sequence of the measuring units and a number of connections of the measuring units; and
the transport controller controls the operation of the transport device in accordance with the connection sequence information and the number of connections of the measuring units.

9. The sample analyzer according to claim 3, wherein the connection state information obtainer obtains the connection sequence information relating to the connection sequence of the measuring units by the differences of the connection lines connecting the measuring units and the measurement control device.

10. The sample analyzer according to claim 9, wherein the connection lines have lengths respectively corresponding to the distances between the control device and the measuring units.

11. The sample analyzer according to claim 3, wherein the connection line comprises a USB cable; and
the connection state information obtainer automatically obtains the connection state information when at least one of the measuring units are connected to the measurement control device.

12. The sample analyzer according to claim 1 further comprising a determiner for determining whether a new measuring unit has been connected; and
a measurement start screen display for displaying a screen for receiving a measurement start instruction of a standard sample containing a predetermined amount of a predetermined component when the determiner has determined that a new measuring unit has been connected.

13. The sample analyzer according to claim 1 further comprising a plurality of reagent containers for containing reagent for preparing a measurement sample by mixing the reagent with the sample; wherein
at least one of the measuring units is supplied reagent through a connector which can be connected in a batch to a plurality of reagent containers.

14. The sample analyzer according to claim 1, wherein the connection state information comprises a number of connections of the measuring units.

15. A sample measuring method executable by a sample analyzer comprising a plurality of measuring units for measuring a sample, and a transport device for transporting samples to be measured to the respective measuring devices, the method comprising:
detecting connections of the measuring units;
automatically obtaining connection state information relating to connection state of the connected measuring units based on detected results;
controlling the transport device in accordance with the obtained connection state information; and
measuring transported samples.

16. The sample measuring method according to claim 15, further comprising:
automatically updating settings of the transport control program for controlling operation of the transport device in accordance with the obtained connection state information; wherein
the operation of the transport device is controlled by the transport control program with the updated settings.

17. The sample measuring method according to claim 16, further comprising:
extracting the settings of the transport control program based on the obtained connection state information; wherein
the updating of the settings of the transport control program is executed based on the extracted settings.

18. The sample measuring method according to claim 15, further comprising:
automatically updating settings of the operation program for controlling the operation of the measuring units based on the obtained connection state information; wherein
the measurements of the transported samples are controlled by the operation program with the updated settings.

19. The sample measuring method according to claim 15, further comprising:
displaying a screen for receiving a measurement start instruction of a standard sample containing a predetermined amount of a predetermined component when the connections of the measuring units are detected.

20. A computer program product for a sample analyzer comprising a plurality of measuring units for measuring a sample, and a transport device for transporting samples to be measured to the respective measuring units, the computer program product comprising:
a computer readable medium; and
instructions, on the computer readable medium, adapted to enable a general purpose computer to perform operations, comprising:
detecting connections of the measuring units;
automatically obtaining connection state information relating to connection state of the connected measuring units based on detected results;
controlling the transport device in accordance with the obtained connection state information; and
measuring the transported sample.
